(19) United States
(12) Patent Application Publication
(10) Pub. No.: US 2014/0280672 A1
(43) Pub. Date: Sep. 18, 2014

(54) Systems and Methods for Managing Communication Between Devices in an Electrical Power System

(71) Applicant: SCHWEITZER ENGINEERING LABORATORIES, INC, (US)

(72) Inventors: Benjamin S. Day, Pullman, WA (US); Jerry J. Bennett, Pullman, WA (US)

(73) Assignee: SCHWEITZER ENGINEERING LABORATORIES, INC., Pullman, WA (US)

(21) Appl. No.: 13/840,587

(22) Filed: Mar. 15, 2013

(51) Int. Cl. H04L 29/08

(52) U.S. Cl. CPC H04L 67/2842
USPC 709/213

(57) ABSTRACT

Systems and methods for managing communication between devices in an electric power generation and delivery system are disclosed. In certain embodiments, a method for managing communication between devices may include receiving a message including an identifier via a communications interface. In certain embodiments, the identifier may identify a particular publishing device. A determination may be made whether the message is a most recently received message associated with the identifier. If the message is the most recently received message, the message may be stored message in a message buffer associated with the identifier, and transmitted from a device using a suitable queuing methodology.

### TECHNICAL FIELD

This disclosure relates to systems and methods for managing communication between devices in an electric power generation and delivery system and, more particularly, to systems and methods for managing communication between network devices and intelligent electronic devices included in an electric power generation and delivery system.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates a simplified diagram of an exemplary electric power generation and delivery system consistent with embodiments disclosed herein

FIG. 2 illustrates an exemplary transmission of messages by an intelligent electronic device consistent with embodiments disclosed herein.

FIG. 3A illustrates intelligent electronic devices communicatively coupled with a network via network devices consistent with embodiments disclosed herein.

FIG. 3B illustrates intelligent electronic devices communicatively coupled with a network via network devices and network radios consistent with embodiments disclosed herein.

FIG. 4 illustrates a system including a message buffer consistent with embodiments disclosed herein.

FIG. 5 illustrates a flow chart of a method for managing communication between devices in an electric power generation and delivery system consistent with embodiments disclosed herein.

### DETAILED DESCRIPTION

The embodiments of the disclosure will be best understood by reference to the drawings. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor do the steps need be executed only once, unless otherwise specified.

In some cases, well-known features, structures, or operations are not shown or described in detail. Furthermore, the described features, structures, or operations may be combined in any suitable manner in one or more embodiments. It will also be readily understood that the components of the embodiments, as generally described and illustrated in the figures herein, could be arranged and designed in a wide variety of different configurations. For example, throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Several aspects of the embodiments disclosed herein may be implemented as software modules or components. As used herein, a software module or component may include any type of computer instruction or computer executable code located within a memory device that is operable in conjunction with appropriate hardware to implement the programmed instructions. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. Indeed, a module or component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a non-transitory machine-readable medium having stored thereon instructions that may be used to program a computer or other electronic device to perform processes described herein. The non-transitory machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions. In some embodiments, the computer or other electronic device may include a processing device such as a microprocessor, microcontroller, logic circuitry, or the like. The processing device may further include one or more special purpose processing devices such as an application specific interface circuit (ASIC), PAL, PLA, PLD, field programmable gate array (FPGA), or any other customizable or programmable device.

Electrical power generation and delivery systems are designed to generate, transmit, and distribute electrical energy to loads. Electrical power generation and delivery systems may include equipment, such as electrical generators, electrical motors, power transformers, power transmission and distribution lines, circuit breakers, switches, buses, transmission lines, voltage regulators, capacitor banks, and the like. Such equipment may be monitored, controlled, automated, and/or protected using intelligent electronic devices (IEDs) that receive electric power system information from the equipment, make decisions based on the information, and provide monitoring, control, protection, and/or automation outputs to the equipment.

In some embodiments, an IED may include, for example, remote terminal units, differential relays, distance relays, directional relays, feeder relays, overcurrent relays, voltage regulator controls, voltage relays, breaker failure relays, generator relays, motor relays, automation controllers, bay controllers, meters, recloser controls, communication processors, computing platforms, programmable logic controllers (PLCs), programmable automation controllers, input and output modules, governors, exciters, statcom controllers, static VAR compensator (SVC) controllers, on-load tap changer (OLTC) controllers, and the like. Further, in some embodiments, IEDs may be communicatively connected via a network that includes, for example, multiplexers, routers, hubs, gateways, firewalls, and/or switches to facilitate communications on the networks, each of which may also function as an IED. Networking and communication devices may also be integrated into an IED and/or be in communication with an IED. As used herein, an IED may include a single discrete IED or a system of multiple IEDs operating together.

IEDs may communicate with other IEDs, monitored equipment, and/or network devices using one or more suitable communication protocols and/or standards. In certain embodiments one or more IED devices included in an electric power generation and delivery system may communicate using an IEC 61850 GOOSE (Generic Object Oriented Substation Events), SV (Sampled Values, MMS (Manufacturing Messaging Specification), SEL Fast Message (FM), Mirrored Bits®, and/or any other suitable protocol. GOOSE may be similarly utilized to facilitate communication between IEDs and GOOSE-enabled pieces of monitored equipment and/or network devices. For example, using GOOSE, IEDs, monitored equipment, and/or network devices may communicate messages (e.g., GOOSE messages) that include bits, bit pairs, measurement values, and/or any other relevant data elements. In certain circumstances, GOOSE may allow a message generated from a single device to be transmitted to multiple receiving devices (e.g., subscriber devices and/or particular receiving devices designated or identified in a GOOSE message).

Some communications between IEDs, monitored equipment, and/or network devices may be more urgent and/or important than other communications. For example, control data or real time samples used in monitoring, controlling, automating, and/or protecting an electric power generation and delivery system or its components may be particularly valuable for a certain period of time. Under increased network loads, however, it may be difficult for a device to discriminate between urgent and less-urgent communications. For example, a receiving IED may include a finite receiving FIFO that may only store a predetermined number of messages, and thus may not be capable of storing certain messages if a significant number of messages are received in a relatively short period.

Certain systems and methods may be utilized by a receiving IED to optimize the handling of network data by the IED. For example, in some embodiments, systems and methods for managing network communications by an IED may include a FIFO for storing a predetermined number of messages originating from a plurality of other devices and a plurality of buffers each for holding at least one message (e.g., a message buffer), as disclosed in U.S. Patent Publication No. 2011/0069709, the entirety of which is herein incorporated by reference. In such systems and methods, messages received in the FIFO may be examined to determine a subscription identifier with which messages are associated. Messages may then be routed to and stored into an appropriate buffer for accessing and processing by the receiving IED. By utilizing a message buffer, urgent and/or important messages may be stored by a receiving IED even under heavy network message traffic conditions.

Systems and methods disclosed herein may utilize a message buffer in network devices to address issues caused by network and/or communication traffic congestions. In certain embodiments, a method for managing communication messages performed by a network device may include receiving a message and an included identifier via a communications interface of the network device. Using a processor included in the network device, a determination may be made that that the message is the most recently received message associated with the identifier. Based on the determination, the message may be stored in a message buffer associated with the identifier and eventually be transmitted to an IED associated with the network device using a suitable output queuing methodology.

FIG. 1 illustrates a simplified diagram of an exemplary electric power generation and delivery system 100 consistent with embodiments disclosed herein. The systems and methods described herein may be applied and/or implemented in a system such as the exemplary system electric power generation and delivery system 100 illustrated in FIG. 1. The electric power generation and delivery system 100 may include, among other things, an electric generator 102, configured to generate an electrical power output, which in some embodiments may be a sinusoidal waveform. Although illustrated as a one-line diagram for purposes of simplicity, an electrical power generation and delivery system 100 may also be configured as a three-phase power system.

A step-up power transformer 104 may be configured to increase the output of the electric generator 102 to a higher voltage sinusoidal waveform. A bus 106 may distribute the higher voltage sinusoidal waveform to a transmission line 108 that in turn may connect to a bus 120. In certain embodiments, the system 100 may further include one or more breakers 112-118 that may be configured to be selectively actuated to reconfigure the electric power generation and delivery system 100. A step down power transformer 122 may be configured to transform the higher voltage sinusoidal waveform to lower voltage sinusoidal waveform that is suitable for delivery to a load 124.

The IEDs 126-138, illustrated in FIG. 1, may be configured to control, monitor, protect, and/or automate the one or more elements of the electric power generation and delivery system. An IED may be any processor-based device that monitors, controls, automates, and/or protects monitored equipment within an electric power generation and delivery system (e.g., system 100). In some embodiments, the IEDs 126-138 may gather status information from one or more pieces of monitored equipment (e.g., generator 102). Further, the IEDs 126-138 may receive information concerning monitored equipment using sensors, transducers, actuators, and the like. Although FIG. 1 illustrates separate IEDs monitoring a signal (e.g., IED 134) and controlling a breaker (e.g., IED 136), these capabilities may be combined into a single IED.

FIG. 1 illustrates various IEDs 126-138 performing various functions for illustrative purposes and does not imply any specific arrangements or functions required of any particular IED. In some embodiments, IEDs 126-138 may be configured to monitor and communicate information, such as voltages, currents, equipment status, temperature, frequency, pressure, density, infrared absorption, radio-frequency information, partial pressures, viscosity, speed, rotational velocity, mass, switch status, valve status, circuit breaker status, tap status, meter readings, and the like. Further, IEDs 126-138 may be configured to communicate calculations, such as phasors (which may or may not be synchronized as synchrophasors), events, fault distances, differentials, impedances, reactances, frequency, and the like. IEDs 126-138 may also communicate settings information, IED identification information, communications information, status information, alarm information, and the like. Information of the types listed above, or more generally, information about the status of monitored equipment, may be generally referred to herein as monitored system data.

In certain embodiments, IEDs 126-138 may issue control instructions to the monitored equipment in order to control various aspects relating to the monitored equipment. For example, an IED (e.g., IED 136) may be in communication with a circuit breaker (e.g., breaker 114), and may be capable of sending an instruction to open and/or close the circuit breaker, thus connecting or disconnecting a portion of a power system. In another example, an IED may be in communication with a recloser and capable of controlling reclosing operations. In another example, an IED may be in communication with a voltage regulator and capable of instructing the voltage regulator to tap up and/or down. Information of the types listed above, or more generally, information or instructions directing an IED or other device to perform a certain action, may be generally referred to as control instructions.

IEDs 126-138 may be communicatively linked together using a data communications network, and may further be communicatively linked to a central monitoring system, such as a supervisory control and data acquisition (SCADA) system 142, an information system (IS) 144, and/or wide area control and situational awareness (WCSA) system 140. In certain embodiments, various components of the electrical power generation and delivery system 100 illustrated in FIG. 1 may be configured to generate, transmit, and/or receive GOOSE messages, or communicate using any other suitable communication protocol. For example, an automation controller 150 may communicate certain control instructions to IED 126 via messages using a GOOSE communication protocol.

The illustrated embodiments are configured in a star topology having an automation controller 150 at its center, however, other topologies are also contemplated. For example, the IEDs 126-138 may be communicatively coupled directly to the SCADA system 142 and/or the WCSA system 140. The data communications network of the system 100 may utilize a variety of network technologies, and may comprise network devices such as modems, routers, firewalls, virtual private network servers, and the like. Further, in some embodiments, the IEDs 126-138 and other network devices (e.g., one or more communication switches or the like) may be communicatively coupled to the communications network through a network communications interface.

Consistent with embodiments disclosed herein, IEDs 126-138 may be communicatively coupled with various points to the electric power generation and delivery system 100. For example, IED 134 may monitor conditions on transmission line 108. IEDs 126, 132, 136, and 138 may be configured to issue control instructions to associated breakers 112-118. IED 130 may monitor conditions on a bus 152. IED 128 may monitor and issue control instructions to the electric generator 102, while IED 126 may issue control instructions to breaker 116.

In certain embodiments, various IEDs 126-138 and/or higher level systems (e.g., SCADA system 142 or IS 144) may be facilitated by an automation controller 150. The automation controller 150 may also be referred to as a central IED, access controller, communications processor, and/or information processor. In various embodiments, the automation controller 150 may be embodied as the SEL-2020, SEL-2030, SEL-2032, SEL-3332, SEL-3378, or SEL-3530 available from Schweitzer Engineering Laboratories, Inc. of Pullman, Wash., and also as described in U.S. Pat. No. 5,680,324, U.S. Pat. No. 7,630,863, and U.S. Patent Application Publication No. 2009/0254655, the entireties of which are incorporated herein by reference.

The IEDs 126-138 may communicate information to the automation controller 150 including, but not limited to, status and control information about the individual IEDs 126-138, IED settings information, calculations made by the individual IEDs 126-138, event (e.g., a fault) reports, communications network information, network security events, and the like. In some embodiments, the automation controller 150 may be directly connected to one or more pieces of monitored equipment (e.g., electric generator 102 or breakers 112-118).

The automation controller 150 may also include a local human machine interface (HMI) 146. In some embodiments, the local HMI 146 may be located at the same substation as automation controller 150. The local HMI 146 may be used to change settings, issue control instructions, retrieve an event report, retrieve data, and the like. The automation controller 150 may further include a programmable logic controller accessible using the local HMI 146. A user may use the programmable logic controller to design and name time coordinated instruction sets that may be executed using the local HMI 146. In some embodiments, the time coordinated instruction sets may be stored in computer-readable storage medium (not shown) on automation controller 150.

In certain embodiments, the automation controller 150 and/or any other system illustrated in FIG. 1 may be further communicatively coupled with one or more remote systems or IEDs including, for example, a remote SCADA system 153 and/or a remote WCSA system 154 via one or more network devices 156, 158 and/or interfaces.

In certain embodiments, a time coordinated instruction set may be developed outside the automation controller 150 (e.g., using WCSA system 140, or SCADA system 142) and transferred to the automation controller 150 or through the automation controller 150 to the IEDs 126-138 or, in other embodiments without the automation controller 150, directly to the IEDs 126-138, using a communications network, using a USB drive, or the like. For example, time coordinated instruction sets may be designed and transmitted via WCSA system 140. Further, in some embodiments, the automation controller 150 or IEDs 126-138 may be provided from the manufacturer with pre-set time coordinated instruction sets. U.S. Patent Application Publication Nos. 2011/0035076, 2011/0035066, and 2011/0035065) titled Method and Apparatus for Customization, describes such a method, and is hereby incorporated by reference in its entirety.

The automation controller 150 may also be communicatively coupled to a time source (e.g., a clock) 148. In certain embodiments, the automation controller 150 may generate a time signal based on the time source 148 that may be distributed to communicatively coupled IEDs 126-138. Based on the time signal, various IEDs 126-138 may be configured to collect and/or calculate time-aligned data points including, for example, synchrophasors, and to implement control instructions in a time coordinated manner. In some embodiments, the WCSA system 140 may receive and process the time-aligned data, and may coordinate time synchronized control actions at the highest level of the electrical power generation and delivery system 100. In other embodiments, the automation controller 150 may not receive a time signal, but a common time signal may be distributed to IEDs 126-138.

The time source 148 may also be used by the automation controller 150 for time stamping information and data. Time synchronization may be helpful for data organization, real-time decision-making, as well as post-event analysis. Time synchronization may further be applied to network communications. The time source 148 may be any time source that is an acceptable form of time synchronization, including, but not limited to, a voltage controlled temperature compensated crystal oscillator, Rubidium and Cesium oscillators with or without a digital phase locked loops, microelectromechanical systems (MEMS) technology, which transfers the resonant circuits from the electronic to the mechanical domains, or a global positioning system (GPS) receiver with time decoding. In the absence of a discrete time source 148, the automation controller 150 may serve as the time source 148 by distributing a time synchronization signal.

To maintain voltage and reactive power within certain limits for safe and reliable power delivery, an electrical power generation and delivery system may include switched capacitor banks (SCBs) (e.g., capacitor 110) configured to provide capacitive reactive power support and compensation in high and/or low voltage conditions within the electrical power system. For example, when power along a transmission line included in the electrical power system meets certain predetermined criteria, the capacitors within the SCB may be switched on (e.g., via breaker 118) by an IED to maintain a proper balance of reactive power. Further, an electrical power generation and delivery system 100 may include an OLTC configured to control the quality of electric power delivered to loads associated with the electrical power system by varying transformer tap positions within the OLTC. Like the SCB, the functionality of the OLTC may be controlled using an IED.

FIG. 2 illustrates an exemplary transmission of messages 200, 204 by an IED consistent with embodiments disclosed herein. A message may include one or more control instructions, monitored system data, communications with other IEDs, monitored equipment, and/or other network devices, and/or any other relevant communication, message, or data. In certain embodiments, a message may provide an indication as to a data state (e.g., a measured data state) of one or more components and/or conditions within an electrical power generation and delivery system. For example, a message may provide an indication of a measured current and/or voltage exceeding one or more thresholds. A certain data state (e.g., “Data State 1”) may be associated with a measurement exceeding such a threshold, while another data state (e.g., “Data State 2”) may be associated with a measurement exceeding a different threshold. A message indicating a particular data state may be utilized to determine whether the measured current and/or voltage exceed the one or more thresholds. In certain embodiments, such messages may be embodied as GOOSE messages.

In certain embodiments, an IED may transmit to subscribing devices and/or received from transmitting devices messages 200 reflecting a particular measured data state (e.g., “Data State 1”) at periodic intervals at a first communication rate after a certain period in which the measured data state has not changed. For example, if a measured data state has not changed within the last 30 seconds, an IED may transmit messages 200 at periodic intervals at the first communication rate. In certain embodiments, this periodic interval may be relatively long, reflecting that a data state change has not recently occurred. Transmitting similar data state messages periodically may introduce a degree of redundancy, helping to ensure subscribing devices receive messages during periods of network congestion and/or low network bandwidth.

When a state change occurs (e.g., at 202), the IED may transmit and/or receive messages 204 reflecting the changed data state (e.g., “Data State 2”) at periodic intervals having a second communication rate. As illustrated, in certain embodiments, the second communication rate may be faster than the first communication rate. Accordingly, the period between adjacent messages 204 may be shorter than the period between adjacent messages 200. As time progresses following the data state change event 202, the communication rate of the messages 204 may progressively slow to reach, for example, a rate at or near the first communication rate. In this manner, data state messages may be transmitted at a relatively fast rate immediately following a data state change event 202 that progressively slows as the data state change event 202 becomes older.

Transmitting measured state messages at a faster rate after a data state change event 202 may ensure that devices subscribing to the communications (e.g., subscribing IEDs) are more likely to receive the messages indicating the state change more closely to the actual data state change event 202. Transmitting multiple redundant messages at a relatively fast rate, however, may introduce network congestion and/or bandwidth issues in certain network devices (e.g., communication switches, routers, radios, multiplexors, a real-time automation controller, PLCs, and/or the like). Consistent with embodiments disclosed herein, a message buffer may be utilized in such network devices to ensure that data state change messages are properly transmitted and/or routed under congested network or low network bandwidth conditions.

FIG. 3A illustrates IEDs 302-306 communicatively coupled with a network 300 via network switches 308-312 consistent with embodiments disclosed herein. Although embodiments illustrated in FIG. 3A are discussed in reference to network switches 308-312, further embodiments may be implemented in other suitable network devices. As discussed above, IEDs 302-306 may be configured to communicate via a network 300 using messages (e.g., GOOSE messages) that, in certain embodiments, may provide an indication as to a data state of one or more components and/or conditions within an electrical power generation and delivery system

The network switches 308-312 may be configured to receive messages from the network 300 and to transmit (e.g., pass) certain messages to an associated IED 302-306. For example, network switch 308 may be configured to receive messages from the network 300 and to transmit certain of the received messages to IED 302. As discussed above, in certain circumstances, a receiving IED (e.g., IED 302) may include a finite receiving FIFO that may only store a predetermined number of messages, and thus may not be capable of storing certain messages if a significant number of messages are received in a relatively short period (e.g., during periods of high network message traffic). Similarly, a network switch (e.g., network switch 308) may have a limited transfer rate but a less restrictive receiving rate. For example, a network switch may have a 1 MB/second data transfer rate but a receiving rate that is substantially greater. If such a network switch includes a finite receiving and/or transmitting buffer and a substantial amount of data (e.g., messages) is received by such a network switch in a short period of time, the network switch may be unable to transmit received messages before the finite buffers become full and messages are lost.

Consistent with certain embodiments, network switches 308-312 may include one or more message buffers configured to store a most recent message of a number of messages received from the network 300. As detailed below in reference to FIG. 4, messages stored in the one or more message buffers may be transmitted to a receiving IED 302-306, thereby ensuring that the most recent messages (e.g., the “freshest” messages) are transmitted to the one or more IEDs 302-306, regardless of whether the network switches 308-312 are capable of processing all incoming message traffic from the network 300.

FIG. 3B illustrates IEDS 302-306 communicatively coupled with a network 300 via network devices 308, 312 and network radios 314, 316 consistent with embodiments disclosed herein. Certain elements of the exemplary system illustrated in FIG. 3A may be similar to those illustrated in and described in reference to FIG. 3B, and, accordingly, similar elements may be denoted with like numerals. As with FIG. 3A, although certain illustrated embodiments are discussed in reference to network switches 308, 312 and network radios 314, 316, further embodiments may be implemented in other suitable network devices.

IEDs 302-306 may be configured to communicate via a network 300 using messages (e.g., GOOSE messages) that, in certain embodiments, may provide an indication as to a data state of one or more components and/or conditions within an electrical power generation and delivery system. The network switches 308, 312 and/or and network radios 314, 316 may be configured to receive messages from the network 300 and to transmit (e.g., pass) certain messages to an associated IED 302-306. For example, network switch 308 may be configured to receive messages from the network 300 and to transmit certain of the received messages to IED 302. Similarly, IED 304, may communicate (e.g., exchange messages) with the network 300 via one or more network radios 314, 316 or other similar network devices implementing a wireless communication methodology.

In certain circumstances, a receiving IED (e.g., IED 304) may include a finite receiving FIFO that may only store a predetermined number of messages, and thus may not be capable of storing certain messages if a significant number of messages are received in a relatively short period (e.g., during periods of high network message traffic). Similarly, a network radio (e.g., network radio 314) may have a limited transfer rate but a less restrictive receiving rate. For example, network radio 314 may have a 1 MB/second data transfer rate but a receiving rate that is substantially greater, thereby creating asymmetry between inbound and outbound communication rates. Similarly, a wireless communication channel between network radio 314 and network radio 316 may have limited bandwidth. In certain embodiments, network devices and/or IEDs may have insufficient computing resources to process network traffic at “wire speed.”. Messages may be lost or delayed due to these and other types of communication bottlenecks.

Consistent with certain embodiments, to mitigate issues attributed to network bottlenecking, network switches 308, 312 and/or and network radios 314, 316 may include one or more message buffers configured to store a most recent message of a number of messages received from the network 300. As detailed below in reference to FIG. 4, messages stored in the one or more message buffers may be transmitted to a receiving IED 302-306, thereby ensuring that the most recent messages (e.g., the “freshest” messages) are transmitted to the one or more IEDs 302-306, regardless of whether the network switches 308, 312 and/or and network radios 314, 316 are capable of processing all incoming message traffic from the network 300.

FIG. 4 illustrates a system 400 including a message buffer 406 consistent with embodiments disclosed herein. In certain embodiments, the system 400 may be included in a network switch or any other suitable network device. The system 400 may receive incoming messages via, for example, an Ethernet interface or the like. The incoming messages may be embodied as GOOSE messages, although any other suitable message format and/or communication protocol may be utilized. In certain embodiments, the incoming messages may provide an indication of a data state (e.g., a measured data state) of one or more components and/or conditions within an electrical power generation and delivery system, although other message and/or data types are also contemplated.

Incoming messages may be received via the network from one or more IEDs or other system components. In certain embodiments, the incoming messages may be received from IEDs and/or system comments that the system 400 and/or an associated IED subscribe to. For example, as illustrated, a first IED may generate incoming messages A₁-A₄, a second IED may generate incoming messages B₁-B₃, a third IED may generate incoming messages C₁-C₂, an Nth IED may generate incoming Messages N₁-N₂, and so on. As messages are received, they may be placed in a receiving buffer or a receiving FIFO 414 (e.g., a circular buffer). In certain embodiments, the receiving FIFO 414 may have a finite message capacity. A microprocessor included in a network device incorporating system 400 may execute a network data processing module and examine the contents of the FIFO 414. Messages generated by a particular IED may be identified using certain identifying information (e.g., subscription identifiers) included in the received messages.

In certain embodiments, a message may include a frame (e.g., an Ethernet frame) identifying the message as a GOOSE message. Further frames included in the message may include the identification information. In certain embodiments, the identification information may comprise information that may be used to derive the identity of a generating IED. For example, message contents may be examined and used to calculate (e.g., a hash calculation or the like) information identifying a particular publishing IED. Any other suitable message classification and/or publisher identification methodology (e.g., identification bits) may also be as identification information. In further embodiments, message identification methods may be flexible and configurable based on a particular application.

The most recent message received from a particular IED may be stored in a message buffer 406, which in certain embodiments may be embodied as a one-message buffer. For example, as illustrated, the most recent or newest messages (e.g., messages 402a, 402b, 402c . . . 402n) including a particular subscription identifier may be stored in a buffer included in the message buffer 406 associated with the subscription identifier (e.g., buffered messages 404a, 404b, 404c . . . 404n). In certain embodiments, the most recent message received from a particular IED may be determined using, at least in part, identification information included in the received message, timestamp information, data state and/or data state change information, and/or any other suitable information. As the most recent or newest messages including a particular subscription identifier are stored in a discrete buffer associated with the identifier, the likelihood of certain new or fresh messages being lost due to overflow of the receiving FIFO 414 under heavy network and message traffic conditions is reduced, and the transmission of newer or fresher messages can be prioritized.

The system 400 may further include an output message queue 412 that, in certain embodiments, may be embodied as an output FIFO or other similar buffering structure. Fresh messages (e.g., messages 404a, 404b, 404c . . . 404n) stored in the message buffer 406 may be placed in the output message queue 412 for transmission to an associated IED from the network switch or other network device incorporating system 400. In certain embodiments, the order in which messages are placed in the output message queue 412 and are transmitted therefrom may be based on priority information provided by a message priority module 410. For example, messages associating with certain identifiers (e.g., messages originating from certain high priority IEDs) may have a higher priority than messages including other identifiers (e.g., messages originating from lower priority IEDs), and may thus be given a higher transmission priority (e.g., transmitted first). In further embodiments, the order in which the messages are placed in the output message queue 412 and are transmitted therefrom may be based on the relative time the messages were received by the system 400. For example, messages stored in the message buffer 406 may be placed in the output message queue 412 based, at least in part, in the order in which the messages were received by the system 400 (e.g., chronologically, reverse chronologically, or the like). In further embodiments, messages may be placed in the output message queue 412 based, at least in part, on a round robin, a priority-weighted round robin, an interleaving methodology placing the messages in between other communications, and/or any other suitable prioritization and/or queuing methodology.

FIG. 5 illustrates a flow chart of a method 500 for managing communication between devices in an electric power generation and delivery system consistent with embodiments disclosed herein. Particularly, the illustrated method 500 may be performed by a network system or other network device that, in certain embodiments, may incorporate features of the system 400 illustrated in FIG. 4. At 502, a message including an identifier may be received via a network and/or communication interface of a network device. In certain embodiments, the message may be a GOOSE message and the identifier may be a subscription identifier.

At 504, a determination may be made that the received message is the most recently received message (e.g., freshest) including the identifier. If the received message is the most recently received message associated with the identifier, at 506, the message may be routed to a message buffer associated with the identifier. In certain embodiments, the message buffer may be a one-message buffer. At 508, a determination may be made whether the message buffer associated with the identifier is full. If the buffer is full, at 510, the message buffer may be purged (e.g., emptied or erased). If the message buffer is not full, at 512 the message may be stored in the message buffer associated with the identifier. As discussed above, the message stored in the message buffer may then be placed in an output message queue based on, for example, a priority associated with the corresponding identifier, a relative time in which the message was received by the network device, or any other suitable queuing methodology. The message may then be transmitted by the network device to an associated IED from the output message queue.

While specific embodiments and applications of the disclosure have been illustrated and described, it is to be understood that the disclosure is not limited to the specific configurations and components disclosed herein. Accordingly, many changes may be made to the details of the above-described embodiments without departing from the underlying principles of this disclosure. The scope of the present invention should, therefore, be determined only by the following claims.

What is claimed is:

1. A method for managing communication messages performed by a network device comprising:
receiving a message including an identifier via a communications interface;
determining, using a processor included in the network device, that the message is a most recently received message associated with the identifier;
storing the message in a message buffer associated with the identifier; and
transmitting the stored message to an intelligent electronic device using the communications interface.

2. The method of claim 1, wherein the method further comprises:
prior to storing the message, determining whether the message buffer is full; and
if the message buffer is full, purging the message buffer.

3. The method of claim 1, wherein the message buffer is configured to store one message.

4. The method of claim 1, wherein the identifier is a subscription identifier.

5. The method of claim 1, wherein the message is an IEC 61850 Generic Object Oriented Substation Events (GOOSE) message.

6. The method of claim 1, wherein the method further comprises:
placing the stored message in an output message queue,
wherein transmitting the stored message further comprises transmitting the stored message from the output message queue.

7. The method of claim 6, wherein the stored message is placed in the output message queue based, at least in part, on the order in which the message was received by the network device.

8. The method of claim 6, wherein the stored message is placed in the output message queue based, at least in part, on priority information associated with the identifier.

9. The method of claim 1, wherein the communications interface is a wireless communications interface.

10. A non-transitory computer-readable storage medium storing instructions that, when executed by a processor of a network device for managing communication messages, cause the processor to:
receive a message including an identifier via a communications interface;
determine, using a processor included in the network device, that the message is a most recently received message associated with the identifier;
store the message in a message buffer associated with the identifier; and
transmit the stored message to an intelligent electronic device using the communications interface.

11. The non-transitory computer-readable storage medium of claim 10, wherein the identifier is a subscription identifier.

12. The non-transitory computer-readable storage medium of claim 10, wherein the message is a GOOSE message.

13. The non-transitory computer-readable storage medium of claim 10, wherein the instructions further cause the processor to:
place the stored message in an output message queue,
wherein transmitting the stored message further comprises transmitting the stored message from the output message queue.

14. The non-transitory computer-readable storage medium of claim 13, wherein the stored message is placed in the output message queue based, at least in part, on the order in which the message was received by the network device.

15. The non-transitory computer-readable storage medium of claim 13, wherein the stored message is placed in the output message queue based, at least in part, on priority information associated with the identifier.

16. A network device for managing communication messages in a network comprising:
a network interface configured to receive and transmit messages;
a processor configured to determine that a message including an identifier received via the network interface is a most recently received message including the identifier; and
a message buffer configured to store the message based on the determination made by the processor.

17. The network device of claim 16, wherein the message is a GOOSE message.

18. The network device of claim 16, wherein the network interface is configured to transmit the stored message to an intelligent electronic device communicatively coupled to the network interface.

19. The network device of claim 16, wherein the network interface is a wireless communications interface.
